(19) United States
(12) Patent Application Publication
(10) Pub. No.: US 2022/0163925 A1
(43) Pub. Date: May 26, 2022

(54) SMART WATCH PROTECTION SHELL

(71) Applicant: SHENZHEN MAIKUO TRADING CO., LTD., Shenzhen (CN)

(72) Inventor: YUANQING YOU, Quiandongnan Miao and Dong (CN)

(21) Appl. No.: 17/670,516

(22) Filed: Feb. 14, 2022

(51) Int. Cl. G04B 37/00

(52) U.S. Cl. CPC G04B 37/005

(57) ABSTRACT

The present invention belongs to the technical field of protection shells, specifically discloses a smart watch protection shell, comprising a frame and a protection case, wherein a protection film is covered at a display window of the frame, the protection case is sleeved and attached outside the frame, the protection film, the frame and the protection case are enclosed to form a dial cavity, and two opposing side walls of the dial cavity are provided with relief holes, respectively. According to the smart watch protection shell disclosed in the present invention, not only the sides and the display screen of the dial can be protected, but also the dial is not easy to fall off and prevented from being crushed, which is convenient for users.

### TECHNICAL FIELD

The present invention belongs to the technical field of protection shells, specifically discloses a smart watch protection shell.

### BACKGROUND

With the development of electronic products, protection shells have become popular by taking advantage of the opportunity of mobile phone slimming. The main function of protection shells is to protect electronic products and prevent hard objects from leaving scratches on screens or bodies of electronic products or breaking electronic products.

With the generalization and popularization of various medium and high-end mobile phones, tablet computers and smart watches, the production of protection cases has sprung up like bamboo shoots after a spring rain, especially for smart watches, which, because of its small size and convenient wearing, are becoming more and more popular with people. At present, smart watches have formed a certain brand pattern in the three major fields of adults, children, and the elderly. The development speed of smart watch protection cases is also fast. The existing watch protection shell is integrally formed from silica gel and is simply sleeved on the watch to protect the side of the watch from scratches, with no function of protecting the watch display. At the same time, the watch protection shell, during use, is very easy to fall off and crush the dial.

Thus, inventors are committed to designing a protection shell to solve the above-mentioned problems.

### SUMMARY

The present invention aims to provide a smart watch protection shell, whereby not only the sides and the display screen of the dial can be protected, but also the dial is not easy to fall off and prevented from being crushed.

In order to achieve the above purposes, the present invention adopts a technical solution as follows:

a smart watch protection shell, comprising a frame and a protection case, wherein a protection film is covered at a display window of the frame, the protection case is sleeved and attached outside the frame, the protection film, the frame and the protection case are enclosed to form a dial cavity, and two opposing side walls of the dial cavity are provided with relief holes, respectively.

As an improvement for the smart watch protection shell of the present invention, the protection case is provided with an attachment part in a convex manner, the frame is provided with a hanging table, and the attachment part is attached to the hanging table.

As an improvement for the smart watch protection shell of the present invention, the attachment part is arranged in a circle at the edge of the inner wall of the protection case, the edge of the outer wall of the frame is provided with a circle of outer groove to form the hanging table, and the attachment part is matched with the outer groove.

As an improvement for the smart watch protection shell of the present invention, the hanging table is provided with a circle of inner groove, which is located at the corner of the outer groove.

As an improvement for the smart watch protection shell of the present invention, the side wall of the protection case is provided with a card tray protection part, and the inner wall of the card tray protection part is arranged in an inwardly protruding manner and located in a card tray hole on the frame.

As an improvement for the smart watch protection shell of the present invention, the outer wall of the card tray protection part is arranged in an outwardly protruding manner, and the outer wall of the protection case is provided with a recess, which is arranged in a circle around the card tray protection part.

As an improvement for the smart watch protection shell of the present invention, two inner holes are provided within the recess, and the card tray protection part is located between the two inner holes.

As an improvement for the smart watch protection shell of the present invention, the two relief holes are located on the protection case, two opposing sides of the frame are provided with relief gaps, respectively, and the two relief gaps and the two relief holes are in one-to-one correspondence relationship.

As an improvement for the smart watch protection shell of the present invention, sound holes, button holes and microphone holes are arranged on both the frame and the side wall of the protection case, a magnetic suction hole and two through holes are arranged on the back surface of the protection case, and the magnetic suction hole is located between the two through holes.

As an improvement for the smart watch protection shell of the present invention, a circle of mounting grooves is arranged at the edge of the display window of the frame, the protection film is covered on the mounting groove, and the depth of the mounting groove is greater than the thickness of the protection film.

Compared with the prior art, according to the smart watch protection shell disclosed in the present invention, the protection case is sleeved outside the frame covered with the protection film, so that the protection film, the frame and the protection case enclose a dial cavity for placing the dial, and at the same time, two opposing side walls of the dial cavity are provided with relief holes, through which watchbands reach out, so that not only the sides and the display screen of the dial can be protected, but also the dial is not easy to fall off and prevented from being crushed, which is convenient for users.

### BRIEF DESCRIPTION OF THE DRAWINGS

FIG. 1 is a stereoscopic enlarged view of the smart watch protection shell according to the present invention;

FIG. 2 is a stereoscopic enlarged view of another perspective of the smart watch protection shell according to the present invention;

FIG. 3 is an enlarged section view of the smart watch protection shell according to the present invention;

FIG. 4 is an enlarged view of A in FIG. 3;

FIG. 5 is a stereoscopic enlarged view of the frame in the present invention;

FIG. 6 is a stereoscopic enlarged view of the protection case in the present invention;

FIG. 7 is a stereoscopic enlarged view of the smart watch protection case provided with a dial in the present invention;

FIG. 8 is a stereoscopic exploded view of the smart watch protection case and the dial in the present invention.

### REFERENCE NUMBER LISTING

1, protection case; 11, relief hole; 12, attachment part; 13, through hole; 14, card tray protection part; 141, inner hole; 142, recess; 15, outer sound hole; 16 outer button hole; 17, outer microphone hole; 2, frame; 21, hanging table; 211, inner groove; 22, relief gap; 23, inner sound hole; 24, inner button hole; 25, inner microphone hole; 26, card tray hole; 27, mounting groove; 3, protection film; 4, dial; 41, dial sound hole; 42, button; 43, magnetic chuck; and 44, display screen.

### DETAILED DESCRIPTION

In conjunction with the accompanying drawings, the embodiments of the present invention are specifically illustrated below. The drawings are for reference and illustration only and do not constitute to the limitation on the scope of protection of the present invention.

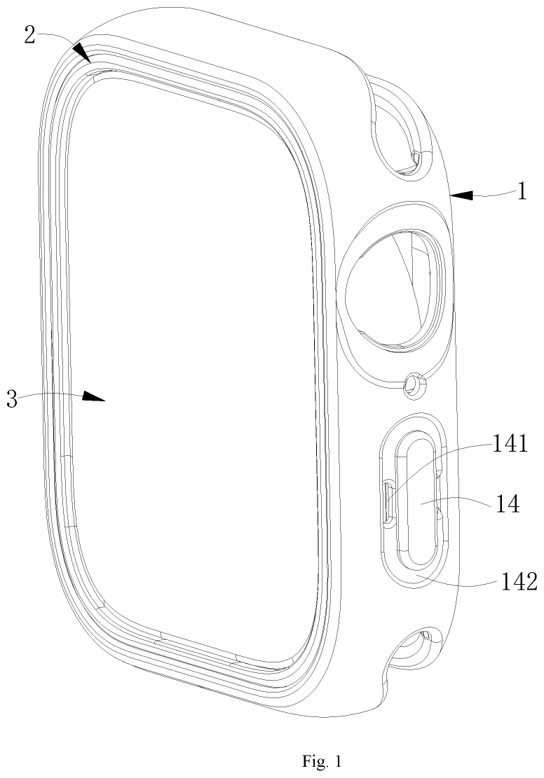

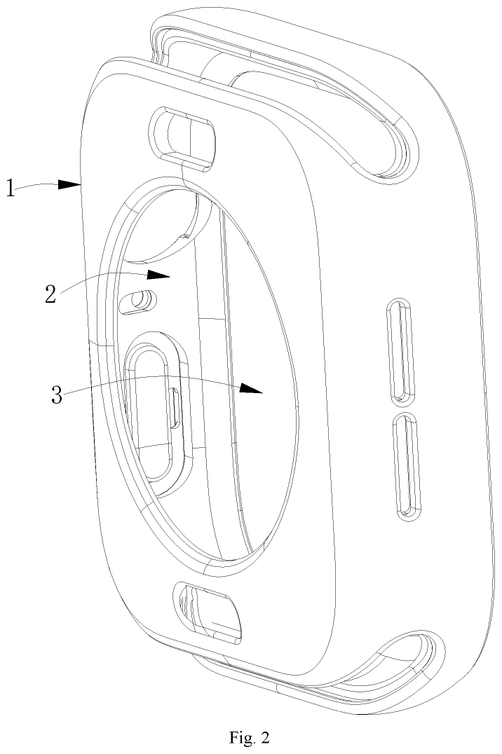

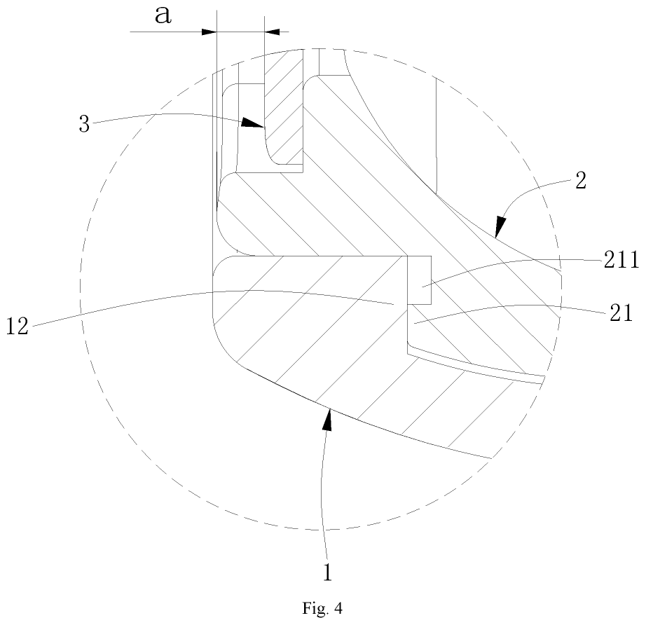

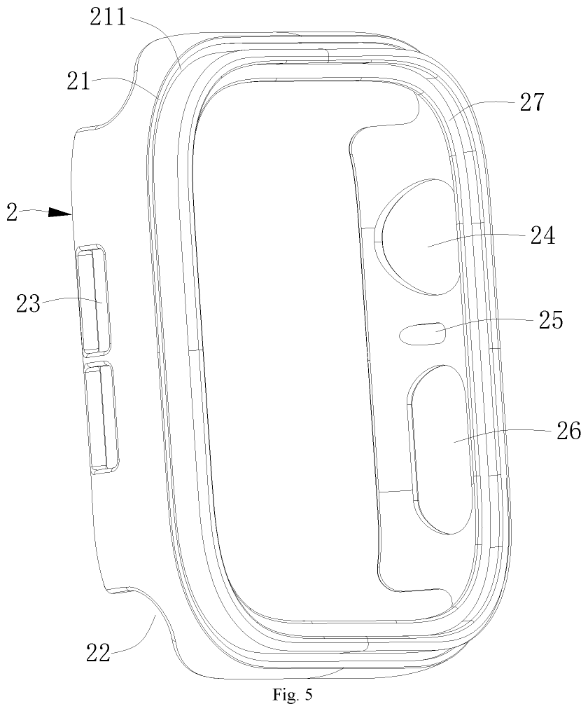

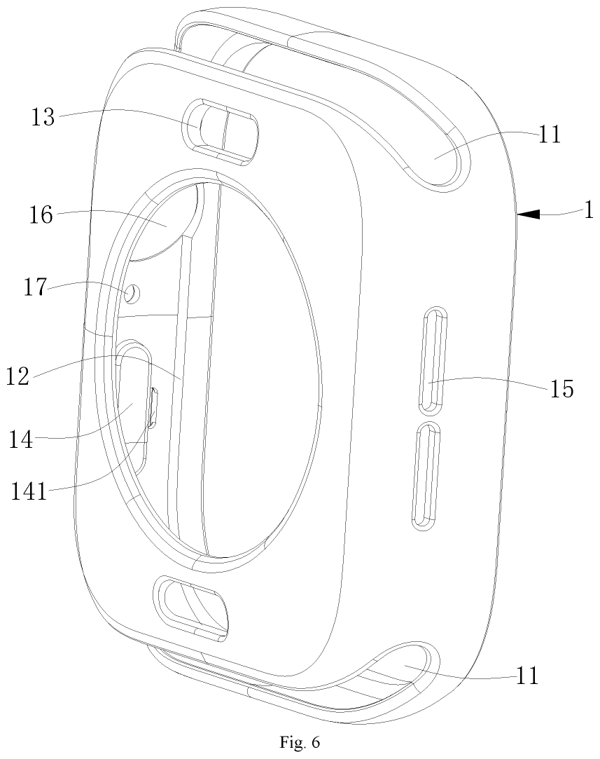

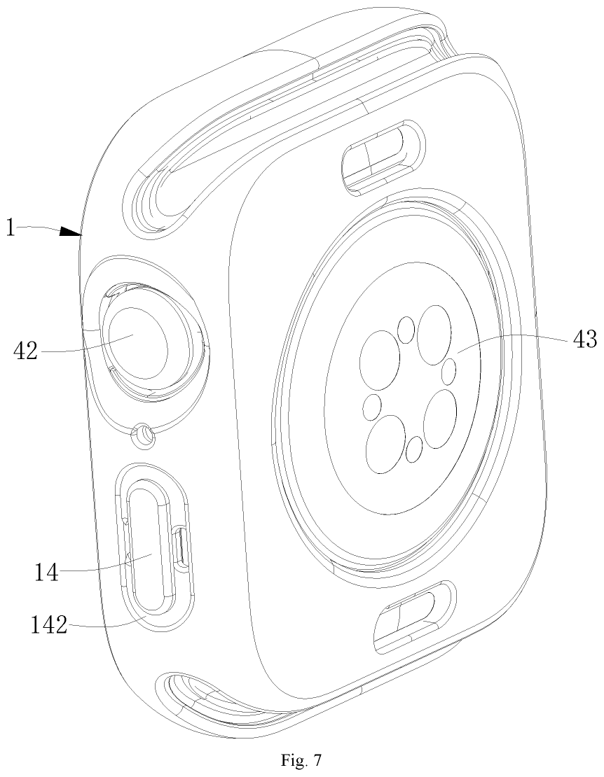

Referring to FIGS. 1 to 7, a smart watch protection shell comprises a frame 2, a protection film 3 and a protection case 1, the protection film 3 is covered at a display window of the frame 2, the protection case 1 is sleeved and attached outside the frame 2, the protection case 1, the frame 2 and the protection film 3 are enclosed to form a dial cavity which is used for receiving a dial 4, two opposing side walls of the dial cavity are provided with a relief hole 11, respectively, and the straps at both ends of the dial 4 can respectively pass through the two relief holes 11 and extend to the outside of the smart watch protection shell, which is convenient for users to wear.

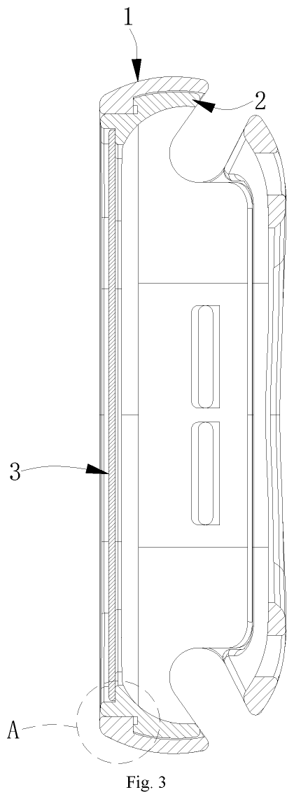

Referring to FIGS. 3 to 5, the frame 2 is made of hard PC plastic material and has a border shape, a circle of mounting groove 27 is provided at the edge of the display window of the frame 2, a circle of outer groove is provided at the edge of the outer wall of the frame 2 to form an annular hanging table 21, the hanging table 21 is provided with a circle of inner groove 211, the inner groove 211 is located at the corner of the outer groove, two opposing sides of the frame 2 are respectively provided with a relief gap 22, the other two opposing sides of the frame 2 are provided with two inner sound holes 23, an inner button hole 24, an inner microphone hole 25 and a card tray hole 26, the two inner sound holes 23 are spaced on one side wall of the frame 2, and the inner microphone hole 25, the inner button hole 24 and the card tray hole 26 are spaced on the other side wall of the frame 2, wherein the inner microphone hole 25 are located between the inner button hole 24 and the card tray hole 26.

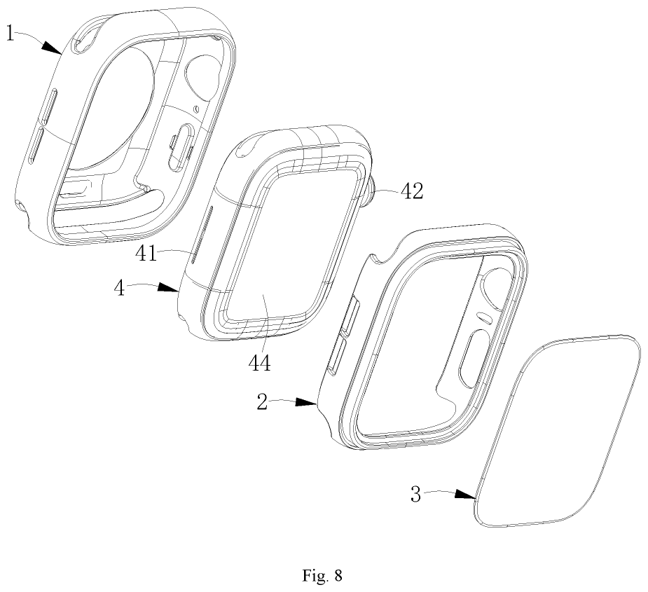

Referring to FIGS. 3, 4, 5 and 8, the protection film 3 is transparent and fixed to the mounting groove 27 of the frame 2. In order to prevent excessive wear of the protection film 3, the depth of the mounting groove 27 is greater than the thickness of the protection film 3, and the difference a between the depth of the mounting groove 27 and the thickness of the protection film 3 is 0.4 mm-0.7 mm, the present embodiments preferring the difference a as 0.6 mm.

Referring to FIGS. 1, 2, 3, 4 and 8, the protection case 1 is made of soft transparent silica gel, the front surface of the protection case 1 is hollow, a circle of annular attachment part 12 is provided at the edge of the inner wall of the protection case 1 in a convex manner, the attachment part 12 is matched with the outer groove and attached to the hanging table 21 of the frame 2, a magnetic suction hole and two through holes 13 are provided on the back surface of the protection case 1, the magnetic suction hole is located between the two through holes 13, the two relief holes 11 are located on two opposing side walls of the protection case 1 and are in one-to-one correspondence relationship with the two relief gaps 22, the other two opposing side walls of the protection case 1 are provided with two outer sound holes 15, an outer button hole 16, an outer microphone hole 17 and a card tray protection part 14, the two outer sound holes 15 are located on one side wall of the protection case 1 and are in one-to-one correspondence relationship with the two inner sound holes 23, and the outer button hole 16, the outer microphone hole 17 and the card tray protection part 14 are located on the other side wall of the protection case 1, wherein the outer microphone hole 17 is located between the outer button hole 16 and the card tray protection part 14, the outer button hole 16 corresponds to the inner button hole 24, the outer microphone hole 17 corresponds to the inner microphone hole 25, the card tray protection part 14 is oval and corresponds to the shape of the outer wall of the card tray of the dial 4, the inner wall of the card tray protection part 14 is arranged in an inwardly protruding manner and extends into the card tray hole 26 on the frame 2, the outer wall of the card tray protection part 14 is arranged in an outwardly protruding manner, the outer wall of the protection case 1 is also provided with an oval recess 142, the recess 142 is arranged as a circle around the card tray protection part 14, two inner holes 141 are provided within the recess 142, and the card tray protection part 14 is located between the two inner holes 141.

Referring to FIGS. 1-8, a method for using the smart watch protection shell according to the present invention comprises: sleeving the frame 2 provided with the protection film 3 on the dial 4 from the front side of the dial 4 so that the display screen 44 of the dial 4 corresponds to the position of the protection film 3, then placing the protection case 1 under the dial 4, making two watchbands respectively pass through the two relief holes 11 on the protection case 1, and sleeving the protection case 1 on the frame 2 upward from the bottom of the dial 4, so that the sound holes 41 on the dial, the inner sound hole 23 and the outer sound hole 15 correspond to each other, the buttons 42 on the dial 4, the inner button hole 24 and the outer button hole 16 correspond to each other, the microphone holes on the dial 4, the inner microphone hole 25 and the outer microphone hole 17 correspond to each other, the card tray on the dial 4, the card tray hole 26 and the card tray protection part 14 correspond to each other, the magnetic chuck 43 on the dial 4 is exposed to the magnetic suction hole, and the protection shell is well installed.

According to the smart watch protection shell disclosed in the present invention, the protection case 1 is sleeved outside the frame 2 covered with the protection film 3, so that the protection film 3, the frame 2 and the protection case 1 enclose a dial cavity for placing the dial 4, and at the same time, two opposing side walls of the dial cavity are provided with relief holes 11, through which watchbands reach out, so that not only the sides and the display screen of the dial 4 can be protected, but also the dial 4 is not easy to fall off and prevented from being crushed, which is convenient for users. The smart watch protection shell of the present invention is mainly applied to Apple watches.

The above disclosed contents are only preferred embodiments of the present invention, not intended to limit the scope of the present invention as claimed. Therefore, equivalent variations made under the scope of the patent application for the present invention are still within the scope of the present invention encompassed.

1. A smart watch protection shell, characterized in comprising a frame and a protection case, wherein a protection film is covered at a display window of the frame, the protection case is sleeved and attached outside the frame, the protection film, the frame and the protection case are enclosed to form a dial cavity, and two opposing side walls of the dial cavity are provided with relief holes, respectively.

2. The smart watch protection shell according to claim 1, wherein the protection case is provided with an attachment part in a convex manner, the frame is provided with a hanging table, and the attachment part is attached to the hanging table.

3. The smart watch protection shell according to claim 2, wherein the attachment part is arranged in a circle at the edge of the inner wall of the protection case, the edge of the outer wall of the frame is provided with a circle of outer groove to form the hanging table, and the attachment part is matched with the outer groove.

4. The smart watch protection shell according to claim 3, wherein the hanging table is provided with a circle of inner groove, which is located at the corner of the outer groove.

5. The smart watch protection shell according to claim 1, wherein the side wall of the protection case is provided with a card tray protection part, and the inner wall of the card tray protection part is arranged in an inwardly protruding manner and located in a card tray hole on the frame.

6. The smart watch protection shell according to claim 5, wherein the outer wall of the card tray protection part is arranged in an outwardly protruding manner, and the outer wall of the protection case is provided with a recess, which is arranged in a circle around the card tray protection part.

7. The smart watch protection shell according to claim 6, wherein two inner holes are provided within the recess, and the card tray protection part is located between the two inner holes.

8. The smart watch protection shell according to claim 1, wherein the two relief holes are located on the protection case, two opposing sides of the frame are provided with relief gaps, respectively, and the two relief gaps and the two relief holes are in one-to-one correspondence relationship.

9. The smart watch protection shell according to claim 1, wherein sound holes, button holes and microphone holes are arranged on both the frame and the side wall of the protection case, a magnetic suction hole and two through holes are arranged on the back surface of the protection case, and the magnetic suction hole is located between the two through holes.

10. The smart watch protection shell according to claim 1, wherein a circle of mounting grooves is arranged at the edge of the display window of the frame, the protection film is covered on the mounting groove, and the depth of the mounting groove is greater than the thickness of the protection film.
